(19) United States
(12) Patent Application Publication
(10) Pub. No.: US 2025/0021754 A1
(43) Pub. Date: Jan. 16, 2025

(54) SYSTEM AND A METHOD FOR ASSESSING SENTENCE SEGMENTATION

(71) Applicant: Interra Systems, Inc., Cupertino, CA (US)

(72) Inventors: Sana Afsar, Noida (IN); Sakshi Jain, Noida (IN); Manik Gupta, Noida (IN)

(73) Assignee: Interra Systems, Inc., Cupertino, CA (US)

(21) Appl. No.: 18/352,743

(22) Filed: Jul. 14, 2023

(51) Int. Cl. G06F 40/211

(52) U.S. Cl. CPC G06F 40/211

(57) ABSTRACT

A method and a system for assessing sentence segmenting in subtitles of a digital content is disclosed. The method comprises of acquiring a source text of the digital content and identifying linguistic boundary within sentences by assigning parts of speech (POS) tags and dependency tags to each word using natural language processing (NLP) libraries. Further, head information is assigned for each word to form a dependency tree structure. And, then, cohesiveness scores are assigned based at least on the parts of speech (POS) tags and the dependency tree structure. The method further includes identifying incorrect lines which violate the linguistic boundary and a set of static rules, and thereby assessing the sentence segmentation in subtitles of a digital content.

### FIELD OF THE DISCLOSURE

The present disclosure is generally related to caption segmentation, and more particularly, related to a system and a method for assessing sentence segmentation of a digital content.

### BACKGROUND OF THE DISCLOSURE

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In a video sequence, there are three types of information present: visual, audio, and textual. The textual information, which is often in the form of captions or subtitles, provides a condensed summary of the content presented in the video. Such textual information becomes a crucial component in understanding and retrieving video data. Captions are essentially lines of text that transcribe the spoken content of a video, such as dialogue or lyrics, and are commonly found in various forms of media, such as movies, television programs, and music videos. Captions also give details about other audio Captions or Subtitles are displayed over video when a dialog starts and are removed from display when the dialog ends. If the dialog is a very long one, then the texts are required to break into a few parts and display it part by part. Additionally, too much text on the display unit hides video elements as well. Generally, it is advisable to put a maximum of 32 characters in one line and 1 to 2 lines in one go. This process of dividing text into a displayable unit is called segmentation. Generally, when captions are generated live, they are written as they are being spoken. When the program is re-telecasted, there is an opportunity to correct the segmentation and make captions more readable.

After transcription or translation, automatic segmentation is mainly performed considering only the maximum number of characters allowed per line. This is because most of the automatic subtitling solutions have not been able to distinguish between the natural pauses in speech and syntactic and semantic information for correct segmentation. The character-based technique can be considered the simplest way to perform segmentation, but it significantly increases the post-editing effort to correct badly segmented subtitles. When a manual reviewer is reviewing the captions and changes segmentation, the start and end times for the text segments need to be re-specified which is a time-intensive activity. It fails to achieve the benefits of automation.

The broadcasters and over-the-top (OTT) providers receive captions (same language as audio) and subtitles (translated from source language) from a variety of vendors. They are in urgent need to assess the quality of subtitle segmentation before broadcasting it. The quality of the captions or subtitles does not only depend on accuracy, completeness, and alignment but also on the way they appear on the display unit. They should not cover too much of the display unit, should be presented with appropriate reading speed, should have adequate display duration, and should be readable by putting linguistically coherent information together and not putting a line break separating dependent words from each other. However, these captions do not meet these criteria and therefore create difficulty for the end users to read the captions and simultaneously watch the content.

Therefore, there is a need for an improved system and method for segmenting subtitles of a video content without compromising text readability while keeping visibility ratio of display criteria in check.

### SUMMARY OF THE DISCLOSURE

By way of introduction, the preferred embodiments described below include a method for assessing and segmenting subtitles of a digital content. The method comprises of acquiring a source text of the digital content and identifying linguistic boundary within sentences by assigning part of speech (POS) tags and dependency tags using natural language processing (NLP) libraries to each word of the group of texts. Herein, the dependency tags correspond to a syntactic dependency, and the syntactic dependency is a relation between two words in a sentence with one word being governor and other being dependent of the relation. The method further assigns head information for each word of the groups of texts to form a dependency tree structure. Further, cohesiveness scores are assigned based at least on the part of speech (POS) tags and the dependency tree structure. The NLP libraries are used to automatically determine good line breaks and cohesiveness of lines with each other to determine block breaks. Further, the method comprises of identifying incorrect lines which violate the linguistic boundary and a set of static rules, and thereby assessing the sentence segmentation in subtitles of a digital content. The set of static rules includes at least a number of rows per block, number of characters in every line, reading speed, display duration, block breaks added at long pauses, balance in line length in case of more than 1 line in a block and minimum possible breaks.

Further, the method comprises of determining ideal line and block breaks for the sentence by using dynamic programming (DP) to satisfy breaks at the linguistic boundary along with the static rules. Further, the ideal line and block break of the identified violated sentence is based at least on assigning CanBreak (CB) points and CanNotBreak (CNB) points between words by using the dependency tags, the head information, and the dependency tree structure. Further, putting line break at linguistic boundary using the CB points, the CNB points, and the cohesiveness scores, identified from all such possible linguistic boundaries using Dynamic Programming so that minimum number of lines are formed, and the static rules are also satisfied. And, the one or more clauses are grouped into the minimum number of lines to satisfy the restriction for max row count per group.

According to an embodiment, a system for assessing sentence segmenting in subtitles of a digital content, is disclosed. The system comprises a memory and a processor coupled to the memory. The processor is configured to execute instructions stored in the memory and is configured to acquire a source text of the digital content and identifying linguistic boundary within sentences by assigning part of speech (POS) tags and dependency tags using natural language processing (NLP) libraries to each word of the group of texts. Herein, the dependency tags correspond to a syntactic dependency, and the syntactic dependency is a relation between two words in a sentence with one word being governor and other being dependent of the relation. Further, head information is assigned for each word of the groups of texts to form a dependency tree structure. And, cohesiveness scores are assigned, based at least on the part of speech (POS) tags and the dependency tree structure. The NLP libraries are used to automatically determine good line breaks and cohesiveness of lines with each other to determine block breaks. Further, the system, identifies incorrect lines which violate the linguistic boundary and a set of static rules, and thereby assessing the sentence segmentation in subtitles of a digital content. The set of static rules include at least a number of rows per block, number of characters in every line, reading speed, display duration, block breaks added at long pauses, balance in line length in case of more than 1 line in a block and minimum possible breaks.

Further, the system determines ideal line and block breaks for the sentence by using dynamic programming (DP) to satisfy breaks at the linguistic boundary along with the static rules. Further, the ideal line and block break of the identified violated sentence is based at least on assigning CanBreak (CB) points and CanNotBreak (CNB) points between words by using the dependency tags, the head information, and the dependency tree structure. Then, putting line break at linguistic boundary using the CB points, the CNB points, and the cohesiveness scores, identified from all such possible linguistic boundaries using Dynamic Programming so that minimum number of lines are formed, and the static rules are also satisfied. Then, the minimum number of lines are grouped into one or more blocks to satisfy the restriction for max row count per block. Herein, the dependency tree structure uses the one or more static rules of total number of lines per display and total number of characters per line.

According to an embodiment, a non-transitory computer-readable medium for storing instructions wherein the instructions are executed by at least one processor, is disclosed. The at least one processor is configured to acquire a source text of the digital content and identifying linguistic boundary within sentences by assigning part of speech (POS) tags and dependency tags to each word using natural language processing (NLP) libraries. Further, head information is assigned for each word to form a dependency tree structure; and cohesiveness scores are assigned based at least on the parts of speech (POS) tags and the dependency tree structure. Further, the non-transitory computer-readable medium is configured to identify incorrect lines which violate the linguistic boundary and a set of static rules, and thereby assessing the sentence segmentation in subtitles of a digital content. The non-transitory computer-readable medium is further configured to determine ideal line and block breaks for the sentence by using dynamic programming (DP) to satisfy breaks at the linguistic boundary along with the static rules. Herein, the set of static rules include at least a number of rows per block, number of characters in every line, reading speed, display duration, block breaks added at long pauses, balance in line length in case of more than 1 line in a block and minimum possible breaks.

Further, the ideal line and block break of the identified violated sentence is based at least on assigning canbreak (CB) points and cannotbreak (CNB) points between words by using the dependency tags, the head information, and the dependency tree structure. Also, put line break is put at linguistic boundary using the CB points, the CNB points, and the cohesiveness scores, identified from all such possible linguistic boundaries using Dynamic Programming so that minimum number of lines are formed, and the static rules are also satisfied. Then, the minimum number of lines are grouped into one or more blocks to satisfy the restriction for max row count per block.

### BRIEF DESCRIPTION OF THE DRAWINGS

The accompanying drawings illustrate various embodiments of systems, methods, and embodiments of various aspects of the disclosure. Any person of ordinary skill in the art will appreciate that the illustrated element boundaries (e.g., boxes, groups of boxes, or other shapes) in the figures represent one example of the various boundaries representative of the disclosed invention. It may be that in some examples one element may be designed as multiple elements or that multiple elements may be designed as one element. In other examples, an element shown as an internal component of one element may be implemented as an external component in another and vice versa. Furthermore, elements may not be drawn to scale. Non-limiting and non-exhaustive descriptions of the present disclosure are described with reference to the following drawings. The components in the figures are not necessarily to scale, emphasis instead being placed upon the illustrated principles.

Various embodiments will hereinafter be described in accordance with the appended drawings, which are provided to illustrate and not to limit the scope of the disclosure in any manner, wherein similar designations denote similar elements, and in which:

FIG. 1 illustrates a block diagram of an automatic segmented subtitling system for assessing sentence segmentation for a digital content, according to an embodiment;

FIG. 2 illustrates a flowchart of a method for assessing sentence segmentation, according to an embodiment;

FIG. 3 illustrates a flowchart of a method for identification of violated groups of texts, according to an embodiment;

FIG. 4 illustrates a flowchart of a method for segmentation of the identified violated groups of texts, according to an embodiment;

FIG. 5 illustrates simple part of speech (POS) tags assigned to the groups of texts, according to an exemplary embodiment; and

FIGS. 6A and 6B illustrate dependency tree structure of the groups of texts, according to an exemplary embodiment.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described. The terms “proximal” and “distal” are opposite directional terms. For example, the distal end of a device or component is the end of the component that is furthest from the practitioner during ordinary use. The proximal end refers to the opposite end, or the end nearest the practitioner during ordinary use.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

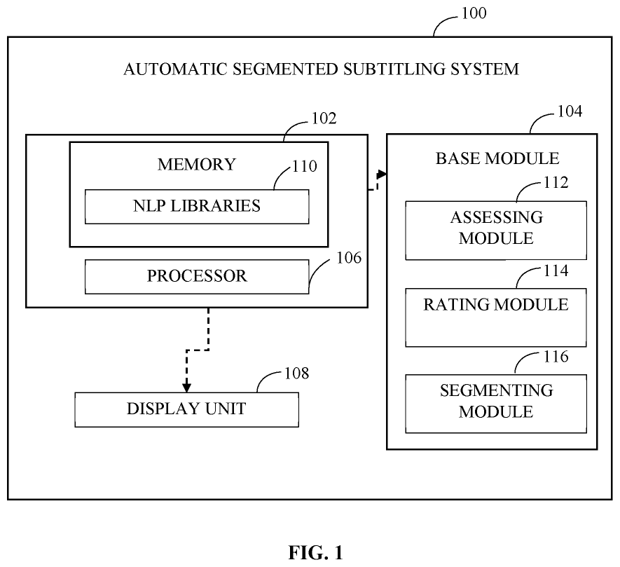

FIG. 1 illustrates a block diagram of an automatic segmented subtitling system 100 for assessing sentence segmentation in subtitles of a digital content, according to an embodiment.

The automatic segmented subtitling system 100 for assessing sentence segmentation in subtitles of a digital content may comprise a memory 102, a base module 104, a processor 106 and a display unit 108. The memory 102 comprises of natural language processing (NLP) libraries 110. Further, the base module 104 includes an assessing module 112, a rating module 114 and a segmenting module 116, without departing from the scope of the present invention.

Hereinafter, the automatic segmented subtitling system 100 is referred as a system 100. In the system 100, the memory 102 stores a set of instructions and data. Further, the memory 102 includes one or more instructions that are executable by the processor 106 to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In an embodiment, the memory 102 may be configured to include program instructions that may be developed to perform translation of one or more text in one or more languages using the NLP libraries 110. Herein, the NLP libraries 110 are pre-built tools that simplifies the one or more text pre-processing to analyze and interpret the one or more text. Further, the one or more text is a source text of a digital content. The NLP libraries 110 provides ability to the system 100 to understand languages in which it is trained. The NLP libraries 110 holds one or more functions that aids in assessing and segmenting subtitles. The NLP libraries 110 understand the one or more text used in the subtitles and captions by using one or more artificial intelligence algorithms. In one embodiment, the NLP libraries 110 are used to automatically determine good segment boundaries and cohesiveness of lines with each other, from the source text of the digital content.

Further, the system 100 may include the processor 106. The processor 106 includes suitable logic, circuitry, and/or interfaces that are operable to execute one or more instructions stored in the memory 102 to perform predetermined operations. The processor 106 may execute an algorithm stored in the memory for detecting the simulated EAS. The processor 106 may also be configured to decode and execute any instructions received from one or more other electronic devices or server(s). The processor 106 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 106 may be further configured to execute one or more computer-readable program instructions, such as program instructions to carry out any of the functions described in the description provided below.

Further, the processor 106 may be further configured to execute one or more program instructions that are developed using the NLP libraries 110 and stored in the memory 102. Further, the processor 106 is be linked to the base module 104. The base module 104 includes the assessing module 112, the rating module 114 and the segmenting module 116. The processor 106 may be configured to access the assessing module 112 that is configured to fetch or acquire the source text of the digital content and identify linguistic boundary within sentences of the group of texts of the source text that is displayed over the display unit 108. The identification of linguistic boundary satisfies some basic criteria or one or more static rules. The criteria or the one or more static rules is described in later part of detailed description. For the sake of clarity, check-in points or one or more static rules or criteria may be used interchangeably throughout the specification. The source text may be captions or subtitles of the digital content. The digital content may include an advertisement, a movie, a program, a news broadcast, an audio and alike. Successively, the assessing module 112 may assign a part of speech (POS) tags and dependency tags using the NLP libraries 110 to each word of the group of texts of the source text. The POS tags includes noun, pronoun, verb, adjective, adverb, preposition, conjunction and interjection in the caption source, as shown in FIG. 5.

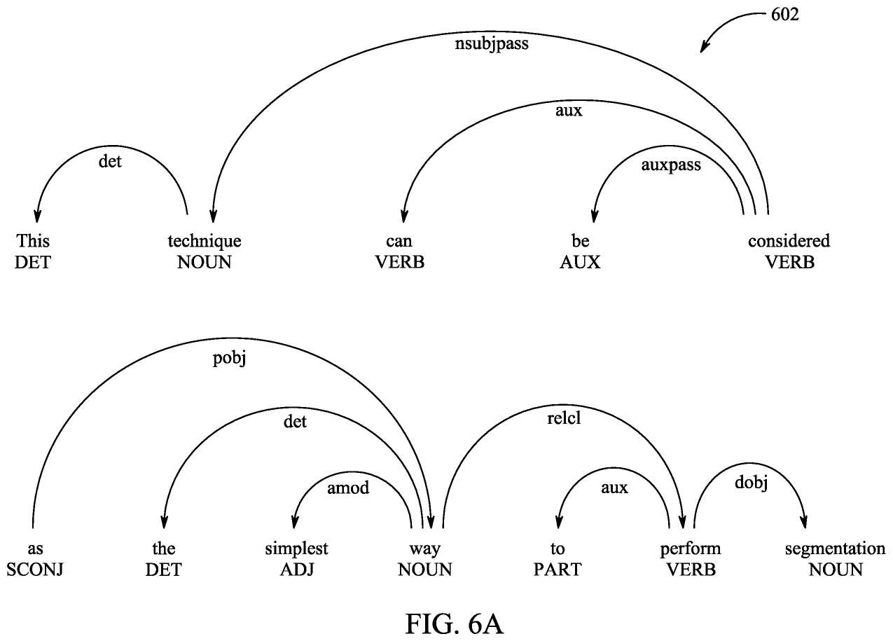

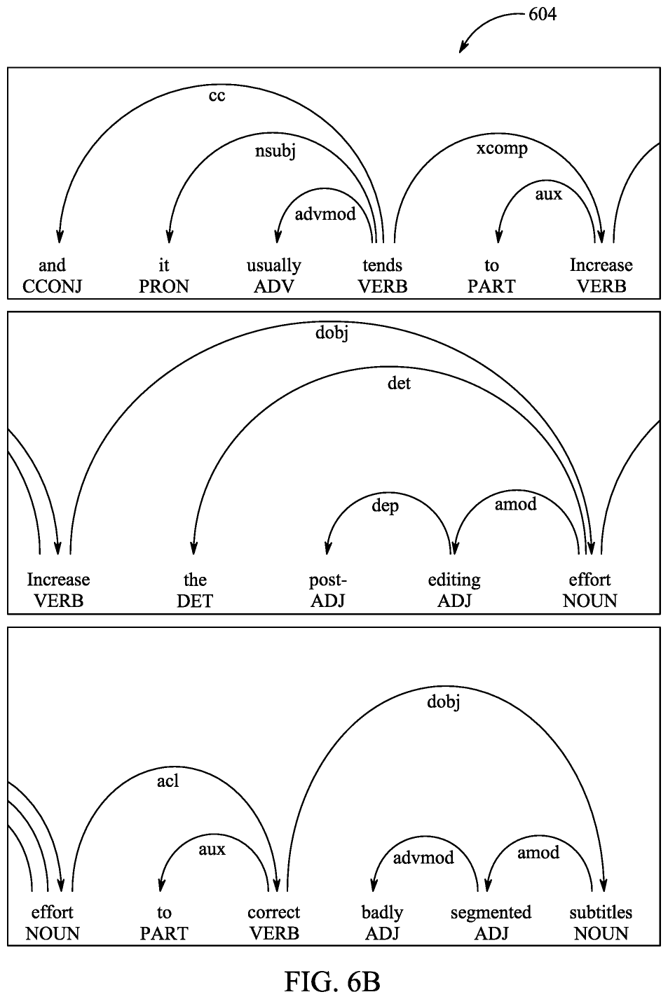

Further, the dependency tags correspond to a syntactic dependency. It can be noted that the syntactic dependency is a relation between two words in a sentence of the group of texts with one word being governor and other being dependent of the relation. Further, the assessing module 112 may assign head information for each word of the groups of texts to form a dependency tree structure 602 and 604, as shown in FIGS. 6A-6B.

Further, the violated groups of texts are flagged on basis of at least on one or more static rules. In one embodiment, the one or more static rules include at least a number of rows per display, number of characters in every row, reading speed, display duration, display breaks added at long pauses, balance in line length in case of more than 1 line in a display and minimum possible breaks.

In one embodiment, a display of the source text or caption text may be referred as one utterance (UTT). The UTT may have a defined start time and end time, at which the UTT may be visible to on a screen. In one embodiment, the UTT may include a sentence or multiple UTTs may form one sentence, depending upon syntactic break point. It is apparent to a person skilled in the art that check-in points 1-5 are easy to identify and are easily flagged. It can be noted that the check-in points may be referred as the one or more static rules or the criteria, and 1-5 static rules are satisfied as soon as the division happens at the linguistic boundary.

In one embodiment, the criteria or the one or more static rules may be explained as:
Point 1: Number of rows per display to ensure captions do not cover significant video portion.
Point 2: Number of characters in every row to ensure it is easy to read captions just by looking at the center of the screen without having to scan across the entire line with eyes. Point 3: Reading speed so that captions do not appear too fast. Point 4: Display Duration so that captions are not stuck for too long to avoid re-reading. Point 5: Display breaks should be added at long pauses and marked with triple dots ( . . . ). Point 6: Dependent words are not separated, like negation from the verb, currency symbol from money, first name from last name, etc. Linguistic units are kept intact to enhance readability. Point 7: Coherent phrases are kept together when a sentence span more than one display unit. This aids readability by keeping the idea intact. Point 8: Balance in line length in case of more than 1 line in a display, if a very short line is followed by a long line, second line might be read before first line. Point 9. Minimum possible breaks are used satisfying the above criteria.

In one embodiment, a user may be provided with an option to specify the severity (info, warning, error, fatal) to each of the above mentioned criteria or static rule. The message reported may have the highest severity of all the failures. For example, if three criteria failed with (info, warning, error) criteria, then the failure message may be reported with ‘error’ severity. An ideal segmentation may also be offered using the above segmentation algorithm.

Further, the restrictions in check-in points 5-9 may be facilitated using one or more advanced NLP-based algorithms or NLP libraries 110. Initially, the sentence is identified in a captions file. After, the POS tags are assigned to all words of the sentence. In one embodiment, the POS tags are assigned using the NLP libraries 110. In an exemplary embodiment, the NLP libraries 110 may include natural language toolkit (NLTK), Spacy and alike.

In one embodiment, words in one branch may be closer to each other than the words in another branch. The words in a branch form a linguistic unit. In one case, when original segmentation separates dependent words or segments words in the linguistic unit, check-in point 6 is flagged.

In one embodiment, the head information may correspond to a word that determines a syntactic category of a phrase. For example, a phrase, “carefully clean that . . . ”, includes head information as, “carefully” is an adverb, “clean” is a verb. Further, the violated groups of texts are identified by comparing the assigned quality score with a predefined threshold range. In one embodiment, the predefined threshold range corresponds to a range of 0 to 100.

Further, the rating module 114 may assign cohesiveness scores based at least on the parts of speech (POS) tags and the dependency tree structure. It can be noted that the precedence order corresponds to a position or a rank or order in which a word in a sentence is presented. Further, the cohesiveness scores are also assigned based on assigning the POS tags to symbols occurring between the group of texts, wherein the symbols include at least one of double quotes, music notes, and triple dots. These POS tags act as syntactic break points.

It can be noted that a break at a higher-order score is preferred over a low-order score. Such units are called clauses. Therefore, words in one clause should be kept together. In one case, a sentence is divided such that a clause boundary is not honored or a break point at higher order score is available, and the line break is put at a lower order score. In this case, the check-in point 7 may be flagged.

Successively, a break at the linguistic boundary may be possible such that the two lines are balanced, and a different break may be chosen which result in un-balanced lines. In this case, the check-in point 8 may be flagged. In another case, when the number of breaks in the segmentation comes out to be less than the number of breaks present in the given caption sentence, the check-in point 9 may be flagged.

Further, the segmenting module 116 may be configured to determine ideal line and block breaks for the sentence by using dynamic programming (DP) to satisfy breaks at the linguistic boundary along with the static rules. In an embodiment, using the DP, a class of issue with the overlapping sub problem can be solved efficiently. Herein, solution to any problem in determining ideal line and block breaks that can be broken down into smaller sub problems, that can then be broken down into even smaller sub problems, and if there is overlap between these sub problems, can be preserved for later use. This increases the effectiveness of processor 106. Further, along with the DP, the NLP libraries 110 are used to automatically determine good line breaks and cohesiveness of lines with each other to determine block breaks. The segmenting module 116 may be configured to segment the groups of texts on basis of different properties.

The segmenting module 116 may be configured to segment the identified violated groups of texts based at least on assigning CanBreak (CB) points and CanNotBreak (CNB) points for the violated groups of texts by using the dependency tags, the head information, and the dependency tree structure. Further, the segmenting is performed based at least on dividing the groups of texts which exceed the restriction for line length, from one or more syntactic boundaries and one or more semantic boundaries to form one or more clauses using the CB points, the CNB points, and the cohesiveness scores. Successively, the segmenting is done based at least on grouping the one or more clauses into one or more segmented groups of texts to satisfy the restriction for max row count per group.

In one embodiment, the groups of texts are segmented such that each sentence are meaningful and cohesive segments are kept in a single sentence. The groups of texts may not exceed character limit and allowable line limit. It can be noted that the segmenting module 116 may be configured to avoid un-necessary segmentation, if it is not required. Further, the duration of displaying these groups of texts are kept in check such that the readability is easy for the viewer. The reading speed is also optimal as per target readers and the segmentation is done on basis of pauses in speech through different symbols. The symbols include double quotes, music notes, conjunctions, punctuations, long pauses.

In one embodiment, the segmenting module 116 divides a single sentence into multiple lines and multiple display unit, upon which cohesive lines are put together in one display. Also, the line breaks are put in a semantically correct position, e.g., not separating the first name from the last name.

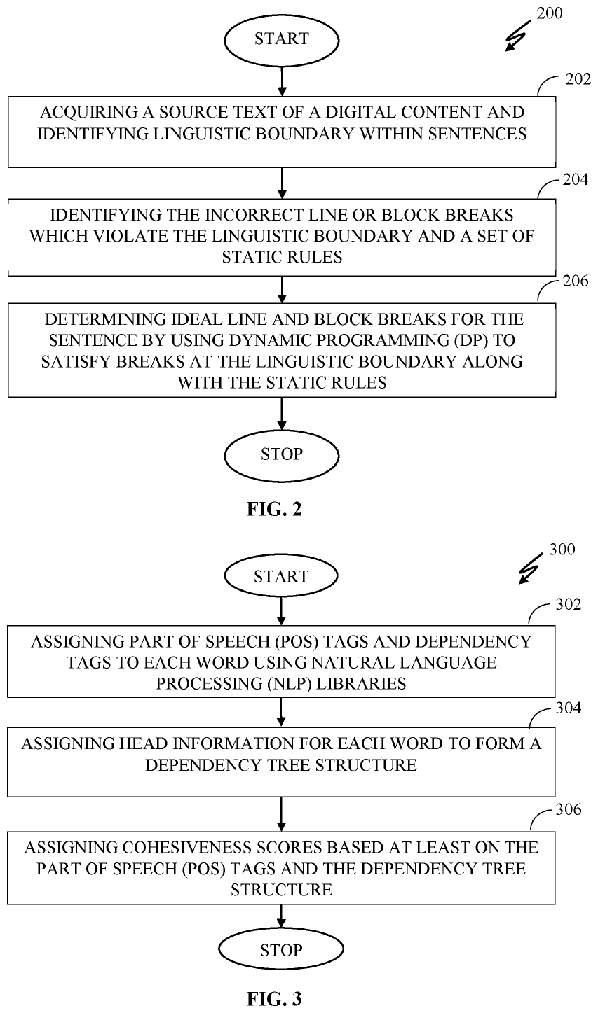

FIG. 2 illustrates a flowchart 200 for a method for assessing and segmenting subtitles of the digital content. FIG. 2 is explained in conjunction with FIGS. 3-6B, and the elements disclosed in FIG. 1.

The flowchart 200 of the FIG. 2 shows the operation for assessing and segmenting subtitles of the digital content. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in the FIG. 2 may be executed substantially concurrently or the blocks may sometimes be executed in the reverse order, depending upon the functionality involved.

Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 206.

At first, the method 200 comprises of acquiring a source text of the digital content and identifying linguistic boundary within sentences, at step 202. For example, a caption source text is acquired from a documentary stating “This technique can be considered as the simplest way to perform segmentation, and it usually tends to increase the post-editing effort to correct badly segmented subtitles”. Further, the caption source is divided into 2 different lines as displayed over the display unit 108:
Line 1: This technique can be considered as the simplest way to perform segmentation
Line 2: it usually tends to increase the post-editing effort to correct badly segmented subtitles.

Successively, the method includes identifying incorrect lines which violate the linguistic boundary and a set of static rules, and thereby assessing the sentence segmentation in subtitles of a digital content, at step 204. In one embodiment, the incorrect line or block breaks is identified based on the linguistic boundary and a set of static rules or criteria, as described above. In one example, from the groups of texts in Line 1 and Line 2 above, Line 2 is violating a static rule 7 that “Coherent phrases are kept together when a sentence span more than one display unit”. The identification of the violated groups of texts is based on assigning the quality score, which is based on multiple parameters and the one or more static rules, described later in conjunction with FIG. 3. In another example, a static rule identified is 2 to 3 lines allowable per display and 32-42 characters allowable per line.

Successively, the method includes determining ideal line and block breaks for the sentence by using dynamic programming (DP) to satisfy breaks at the linguistic boundary along with the static rules, at step 206 and thereby assessing and segmenting the subtitles of digital content. Herein, the NLP libraries are used to automatically determine good line breaks and cohesiveness of lines with each other to determine block breaks. For example, the violated Line 2 is segmented by assigning break points, such that the Line 1 and Line 2 is segmented as:
Break 1: This technique can be considered
Break 2: as the simplest way to perform segmentation,

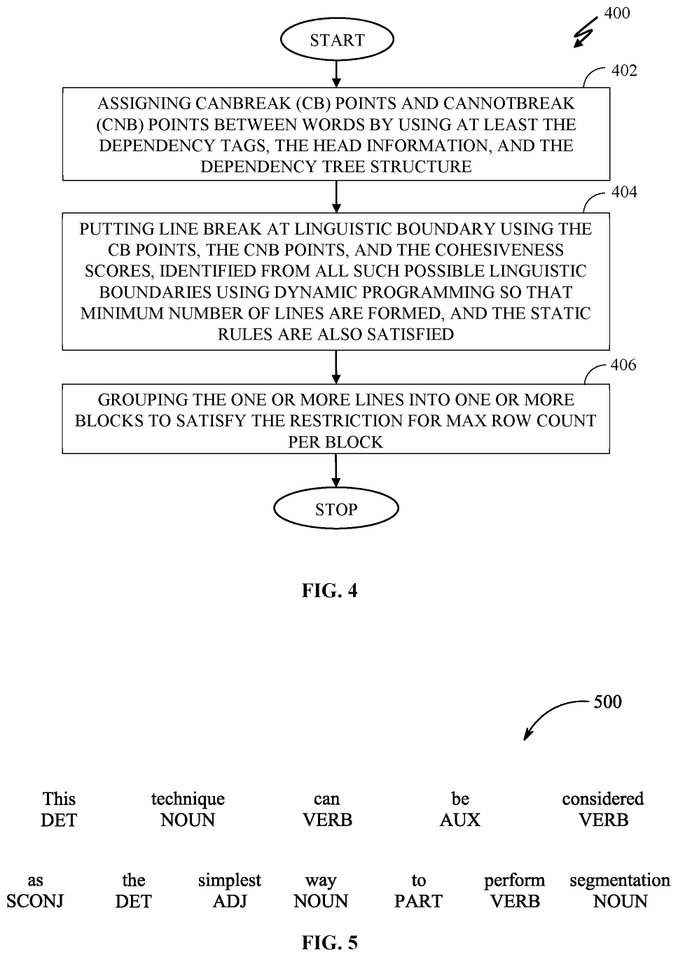

The segmentation of the identified violated groups of texts is based on multiple parameters. These parameters are explained in conjunction with FIG. 4.

In one example, the assessing module 112 evaluates the caption source as divided into groups on the basis of criteria. The criteria include number of rows per display, number of characters in every row, reading speed, display duration, display breaks should be added at long pauses, dependent words are not separated, coherent phrase is not kept together, balance in line length in case of more than 1 line in a display and minimum possible breaks are used satisfying the above criteria.

Further, the criteria of number of rows per display, number of characters in every row, reading speed, display duration, display breaks should be added at long pauses are easy to identify and are easily flagged. In one case, if the groups of texts separate dependent words or segments words in a linguistic unit, then “dependent words are not separated” is flagged. In another case, if the sentence of the groups of texts is divided such that the clause boundary is not honored or the break point at higher order score is available, but the line break may be put at a lower order score, then “coherent phrase is not kept together” is flagged.

Alternatively, if a break at linguistic boundary of the groups of texts is possible such that the two lines are balanced, but a different break is chosen which results in un-balanced lines, then “balance in line length in case of more than 1 line in a display” may be flagged. Additionally, if the number of breaks in ideal segmentation comes out to be less than the number of breaks present in the groups of texts, then “minimum possible breaks” may be flagged.

It can also be noted that one or more users are provided with the option to specify the severity including info, warning, error, fatal to each of the criteria. The message reported will have the highest severity of all the failures.

For example, the subtitle displayed in 2 different lines are given a quality score of 1 out of 5 by the rating module 114 since the lines do not satisfy any of the given criteria. It may be noted that assessing module 112 may also be configured to flag or highlight the particular criteria over the display unit 108 that do not satisfy. Also if any of the given criteria failed with info, warning and error criteria, then the failure message will be flagged with ‘error’ severity. Since, the quality score of the subtitle displayed is 1, therefore the segmenting module 116 is further configured to segment the groups of texts as per the criteria.

FIG. 3 illustrates a flowchart 300 of a method of identifying violated groups of texts from the groups of texts by assigning the quality score, according to an embodiment.

The flowchart 300 of the FIG. 3 shows the architecture, functionality, and operation for identifying violated groups of texts from the groups of texts by assigning the quality score. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in the FIG. 3 may be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 300 starts at the step 302 and proceeds to step 306.

At first, the method includes assigning parts of speech (POS) tags and dependency tags using open source natural language processing (NLP) libraries, at step 302. In one embodiment, the rating module 114 assigns simple POS tags to the text and symbols using the NLP libraries.

In the aforementioned example, the assessing module 112 assigns dependency tags to the groups of texts such as word “This” and word “technique” are dependent to each other. Similarly, words “perform” and word “segmentation” are also dependent with each other. In an embodiment, some types of dependencies are hard dependencies and must not be broken. For example, if the dependency tag is a negation for a word, it will not be separated from its head word. FIG. 5 illustrates simple POS tags 500 assigned to the group of texts.

In one example, the rating module 114 assigns the POS including noun, pronoun, verb, adjective, adverb, preposition, conjunction and interjection in the caption source, as shown in FIG. 4. It may be noted that the part of speech indicates how the word functions in meaning as well as grammatically within a given sentence.

Successively, head information is assigned for each word to form a dependency tree structure, at step 304. For example, “as” (SCONJ) and “and” (CCONJ) are working as clause-break. Using syntactic boundary, it will be segmented as:
Break 1: This technique can be considered
Break 2: as the simplest way to perform segmentation,
Break 3: and it usually tends to increase the post-editing effort to correct badly segmented subtitles. As shown in FIGS. 6A and 6B.

Further, cohesiveness scores are assigned based at least on the parts of speech (POS) tags and the dependency tree structure, at step 306. For example:
Break 1: This technique can be considered
Break 2: as the simplest way to perform segmentation
Break 3: and it usually tends to increase the post-editing effort to correct badly segmented subtitles.

FIG. 4 illustrates a flowchart 400 of a method for segmenting the violated groups of texts, according to an embodiment.

The flowchart 400 of the FIG. 4 shows the architecture, functionality, and operation for segmenting the violated groups of texts. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in the FIG. 4 may be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 400 starts at the step 402 and proceeds to step 406.

At first, the method includes assigning CB points and CNB points between words by using at least the dependency tags, the head information, and the dependency tree structure, at step 402. In one example, phrases such as “usually tends”, “post-editing efforts” and “badly segmented subtitles” false under CNB points and phrases such as “,”, “effort to” false under CB points.

In another example, CB points identified are “increase”, “effort” as shown in FIG. 6B. In another example, CNB points are “tends”, “editing” and “correct” as shown in FIG. 6B.

Successively, the method includes putting line break at linguistic boundary using the CB points, the CNB points, and the cohesiveness scores, identified from all such possible linguistic boundaries using Dynamic Programming so that minimum number of lines are formed, and the static rules are also satisfied, at step 404. In one embodiment, the segmenting module 116 divides a single sentence into multiple lines and multiple display unit, upon which cohesive lines are put together in one display. Also, the line breaks are put in a semantically correct position, e.g., not separating the first name from the last name. In one example:
Break 1: Alex Hales scores a century
Break 2: in a cricket match between
Break 3: Australia and England.

In another example,
Break 1: This technique can be considered
Break 2: as the simplest way to perform segmentation,
Break 3: and it usually tends to increase the post-editing effort to correct badly segmented subtitles.

Further, the minimum number of lines are grouped into one or more blocks to satisfy the restriction for max row count per block, at step 406.

For example:
Break 1: This technique can be considered.

Since this segment has 32 char length, so the line will not be segmented further.
Utterance 1: This technique can be considered.
Break 2: as the simplest way to perform segmentation,
   This segment has a char length of 44, therefore segmentation is further required. For “the”, “simplest” and “way” CB may be false. Further, this information, when segmentation is performed using dynamic programming (DP), utterance 2 may be as follows:
Utterance 2:
   as the simplest way
   to perform segmentation,
Break 3: and it usually tends to increase the post-editing effort to correct badly segmented subtitles.

In one embodiment, the DP may be used to determine ideal break-points between groups of texts to satisfy breaks at the linguistic boundary with one or more static rules and precedence order. It can be noted that the DP finds optimal break points out of all possible break points such that other static rules are also satisfied and an issue is flagged when the break points are not present at the linguistic boundary.

In one example, words “increase”, “effort”, “subtitles” are possible semantic boundaries. In another example, Utterance 1 and Utterance 2 and Break 3 are evaluated.

Further, according to cohesiveness scores given to different types of dependency tags; the first two lines are more cohesive with each other than the last two lines. So, the below utterances may be created since one utterance can contain only 2 lines.
Utterance 3;
   and it usually tends to increase
   the post-editing effort
Utterance 4:
   to correct badly segmented subtitles.

Further, the present invention discloses a non-transitory computer-readable medium for storing instructions, wherein the instructions are executed by at least one processor. The at least one processor is configured to acquire a source text of the digital content and identifying linguistic boundary by assigning part of speech (POS) tags and dependency tags using natural language processing (NLP) libraries to each word. Further, head information is assigned for each word of the source text to form a dependency tree structure. Then, cohesiveness scores are assigned based at least on the part of speech (POS) tags and the dependency tree structure. Then, incorrect lines which violate the linguistic boundary and a set of static rules, are identified and thereby assessing the sentence segmentation in subtitles of a digital content. The set of static rules include at least a number of rows per block, number of characters in every line, reading speed, display duration, block breaks added at long pauses, balance in line length in case of more than 1 line in a block and minimum possible breaks.

The non-transitory computer-readable medium for storing instructions further comprises of determining ideal line and block breaks for the sentence by using dynamic programming (DP) to satisfy breaks at the linguistic boundary along with the static rules. Further, the ideal line and block break of the identified violates sentence is based at least on assigning CB points and CNB points between words by using at least the dependency tags, the head information, and the dependency tree structure. Further, the line break is put at linguistic boundary using the CB points, the CNB points, and the cohesiveness scores, identified from all such possible linguistic boundaries using Dynamic Programming so that minimum number of lines are formed, and the static rules are also satisfied. Then, the minimum number of lines are grouped into one or more blocks to satisfy the restriction for max row count per block.

In an embodiment, the present system and method performs better than training on labeled data as there are no biases and human-error in data labeling. Further, the present invention solves a major pain point in automatic captioning and segmentation. The major complaint against auto-captioning is that if segmentation needs to be re-done manually, then start and end time needs to be re-assigned again. It increases the work of manual captioner and fails the purpose of automation. Also, broadcasters who receive captions from vendors need to check the quality of captions and need an automated tool to do so. They want to automatically correct/re-purpose the captions if there are issues.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. In addition, where this application has listed the steps of a method or procedure in a specific order, it may be possible, or even expedient in certain circumstances, to change the order in which some steps are performed, and it is intended that the particular steps of the method or procedure claim set forth here below not be construed as being order-specific unless Such order specificity is expressly stated in the claim.

### LIST OF ELEMENTS

### Title: A System and a Method for Assessing and Segmenting Subtitles

100: Automatic Segmented Subtitling System
102: Memory
104: Base Module
106: Processor
108: Display Unit
110: NLP Libraries
112: Assessing module
114: Rating Module
116: Segmenting Module
200: Flowchart
202 to 206: Steps
300: Flowchart
302 to 306: Steps
400: Flowchart
402 to 406: Steps
500: Part of Speech (POS) tags
602 and 604: Dependency Tree Structure

What is claimed is:

1. A method for assessing sentence segmentation in subtitles of a digital content, the method comprising:
acquiring a source text of the digital content and identifying linguistic boundary within sentences by:
assigning parts of speech (POS) tags and dependency tags to each word using natural language processing (NLP) libraries;
assigning head information for each word to form a dependency tree structure; and
assigning cohesiveness scores based at least on the POS tags and the dependency tree structure; and
identifying incorrect lines which violate the linguistic boundary and a set of static rules, and thereby assessing the sentence segmentation in subtitles of a digital content.

2. The method of claim 1, wherein the set of static rules comprises at least a number of rows per block, number of characters in every line, reading speed, display duration, block breaks added at long pauses, balance in line length in case of more than 1 line in a block and minimum possible breaks.

3. The method of claim 1, further comprising:
determining ideal line and block breaks for the sentence by using dynamic programming (DP) to satisfy breaks at the linguistic boundary along with the set of static rules.

4. The method of claim 3, wherein the determining of the ideal line and block break for the sentence is based at least on:
assigning CanBreak (CB) points and CanNotBreak (CNB) points between words by using at least the dependency tags, the head information, and the dependency tree structure;
putting line breaks at the linguistic boundary using the CB points, the CNB points, and the cohesiveness scores, identified from linguistic boundaries using the dynamic programming to form a minimum number of lines and satisfy the set of static rules; and
grouping the minimum number of lines into one or more blocks to satisfy restriction for max row count per block.

5. The method of claim 1, wherein the NLP libraries are used to automatically determine good line breaks and cohesiveness of lines with each other to determine block breaks.

6. The method of claim 1, wherein the dependency tags correspond to a syntactic dependency, and the syntactic dependency is a relation between two words in a sentence with one word being governor and other being dependent of the relation.

7. A system for assessing sentence segmentation in subtitles of a digital content, the system comprising:
a memory; and
a processor coupled to the memory, to execute instructions stored in the memory, that is configured to:
acquire a source text of the digital content and identify linguistic boundary within sentences by:
assigning parts of speech (POS) tags and dependency tags to each word using natural language processing (NLP) libraries;
assigning head information for each word to form a dependency tree structure; and
assigning cohesiveness scores based at least on the parts of speech (POS) tags and the dependency tree structure; and
identify incorrect lines which violate the linguistic boundary and a set of static rules, and thereby assessing the sentence segmentation in subtitles of a digital content.

8. The system of claim 7, wherein the set of static rules include at least a number of rows per block, number of characters in every line, reading speed, display duration, block breaks added at long pauses, balance in line length in case of more than 1 line in a block and minimum possible breaks.

9. The system of claim 7, further comprising:
determine ideal line and block breaks for the sentence by using dynamic programming (DP) to satisfy breaks at the linguistic boundary along with the set of static rules.

10. The system of claim 8, wherein the ideal line and block break of the identified violated sentence is based at least on:
assign CanBreak (CB) points and CanNotBreak (CNB) points between words by using at least the dependency tags, the head information, and the dependency tree structure;
put line break at linguistic boundary using the CB points, the CNB points, and the cohesiveness scores, identified from all such possible linguistic boundaries using Dynamic Programming so that minimum number of lines are formed, and the set of static rules are also satisfied; and
group the minimum number of lines into one or more blocks to satisfy the restriction for max row count per block.

11. The system of claim 7, wherein the NLP libraries are used to automatically determine good line breaks and cohesiveness of lines with each other to determine block breaks.

12. The system of claim 7, wherein the dependency tags correspond to a syntactic dependency, and the syntactic dependency is a relation between two words in a sentence with one word being governor and other being dependent of the relation.

13. The system of claim 7, wherein the dependency tree structure uses the one or more static rules of total number of lines per display and total number of characters per line.

14. A non-transitory computer-readable medium for storing instructions which when executed by at least one processor causes the at least one processor to:
acquire a source text of the digital content and identify linguistic boundary within sentences by:
assigning parts of speech (POS) tags and dependency tags to each word using natural language processing (NLP) libraries;
assigning head information for each word to form a dependency tree structure; and
assigning cohesiveness scores based at least on the parts of speech (POS) tags and the dependency tree structure; and
identify incorrect lines which violate the linguistic boundary and a set of static rules, and thereby assessing the sentence segmentation in subtitles of a digital content.

15. The non-transitory computer-readable medium of claim 14, further comprising:
determine ideal line and block breaks for the sentence by using dynamic programming (DP) to satisfy breaks at the linguistic boundary along with the set of static rules.

16. The non-transitory computer-readable medium of claim 14, wherein the ideal line and block break of the identified violated sentence is based at least on:
assign CanBreak (CB) points and CanNotBreak (CNB) points between words by using at least the dependency tags, the head information, and the dependency tree structure;
put line break at linguistic boundary using the CB points, the CNB points, and the cohesiveness scores, identified from all such possible linguistic boundaries using Dynamic Programming so that minimum number of lines are formed, and the set of static rules are also satisfied; and
group the minimum number of lines into one or more blocks to satisfy the restriction for max row count per block.

17. The non-transitory computer-readable medium of claim 14, wherein the set of static rules include at least a number of rows per block, number of characters in every line, reading speed, display duration, block breaks added at long pauses, balance in line length in case of more than 1 line in a block and minimum possible breaks.
